(19) United States
(12) Patent Application Publication
(10) Pub. No.: US 2026/0050259 A1
(43) Pub. Date: Feb. 19, 2026

(54) SECURITY OF TELEASSISTANCE OPERATING MODES IN AUTONOMOUS SYSTEMS AND APPLICATIONS

(71) Applicant: NVIDIA Corporation, Santa Clara, CA (US)

(72) Inventor: Sanjay TRIVEDI, Banglore (IN)

(21) Appl. No.: 18/805,479

(22) Filed: Aug. 14, 2024

(51) Int. Cl. G05D 1/223; G05D 1/227; G05D 109/10

(52) U.S. Cl. CPC G05D 1/223; G05D 1/227; G05D 2109/10

(57) ABSTRACT

The present disclosure relates to reducing vulnerabilities associated with teleassistance operating modes. In particular, in some embodiments, a system may include a control system configured to control one or more operations of a machine, in which the control system has a first operating mode (e.g., a non-teleassistance mode) and a second operating mode (e.g., a teleassistance mode). The system may further include a mechanical selector configured to cause selection between the first operating mode and the second operating mode via a mechanical mechanism.

### BACKGROUND

Machines that perform autonomous and/or semi-autonomous planning, control, and/or navigation operations, which may be referred to herein as “ego-machines”, may perform the operations without human input or with reduced human input. As ego-machines become more automated, certain risks may increase. For example, some situations may occur in which autonomous systems may have difficulties in decision making and/or execution of maneuvers, which may cause issues with respect to the safety of the ego-machines, objects around the ego-machines, and/or the passengers of the ego-machines.

Some approaches of improving safety of ego-machines may include operating the ego-machines, via a control system, in a teleassistance mode. The teleassistance mode may include the ego-machine communicating with a remote operation system. For example, the control system may communicate data related to the operations of the ego-machine and/or information on the ego-machine's internal systems to the remote operation system. The teleassistance mode may include causing the ego-machine to perform one or more operations based at least on instructions received from the remote operation system. For example, the remote operation systems may be configured to communicate control commands to the control system and the control system may then cause its corresponding ego-machine to perform the one or more control operations (e.g., braking, acceleration, steering, etc.) based on the received control commands.

However, in some instances, traditional approaches for enabling teleassistance may include and/or increase security vulnerabilities. For example, the teleassistance mode may provide an avenue for malicious parties (e.g., hackers, etc.) to access data corresponding to ego-machines and/or to take control of the ego-machines through unauthorized enablement of the teleassistance mode. Such vulnerabilities may expose sensitive information to unauthorized parties and/or allow for such parties to cause the ego-machines to perform undesired operations (e.g., actuations) that may affect safety.

### SUMMARY

According to one or more embodiments of the present disclosure, systems and methods may be configured to help reduce vulnerabilities associated with teleassistance operating modes. In particular, in some embodiments, a system may include a control system configured to control one or more operations of a machine, in which the control system has a first operating mode (e.g., a non-teleassistance mode) and a second operating mode (e.g., a teleassistance mode). The system may further include a mechanical selector configured to cause selection between the first operating mode and the second operating mode via a mechanical mechanism.

The use of a mechanical mechanism to enable the teleassistance mode may help improve security associated with operating in a teleassistance mode. For example, the mechanical mechanism may be such that the enabling of the teleassistance mode is required to be performed at the machine itself such that the ability of unauthorized parties to remotely engage the teleassistance mode may be reduced or eliminated.

### BRIEF DESCRIPTION OF THE DRAWINGS

The present systems and methods for improving security associated with operating in teleassistance operating mode are described in detail below with reference to the attached figures, wherein:

FIG. 1A is a diagram illustrating an example system which may be configured to select an operating mode of an ego-machine, in accordance with one or more embodiments of the present disclosure;

FIG. 1B illustrates an example mechanical selector, in accordance with one or more embodiments of the present disclosure;

FIG. 2 is a diagram illustrating an example mode selection system, in accordance with one or more embodiments of the present disclosure;

FIG. 3 is a diagram illustrating another example mode selection system, in accordance with one or more embodiments of the present disclosure;

FIG. 4 illustrates a flow diagram for a method of switching an operating mode of a control system, in accordance with one or more embodiments of the present disclosure;

FIG. 5A is an illustration of an example autonomous vehicle, in accordance with one or more embodiments of the present disclosure;

FIG. 5B is an example of camera locations and fields of view for the example autonomous vehicle of FIG. 5A, in accordance with one or more embodiments of the present disclosure;

FIG. 5C is a block diagram of an example system architecture for the example autonomous vehicle of FIG. 5A, in accordance with one or more embodiments of the present disclosure;

FIG. 5D is a system diagram for communication between cloud-based server(s) and the example autonomous vehicle of FIG. 5A, in accordance with one or more embodiments of the present disclosure;

FIG. 6 is a block diagram of an example computing device suitable for use in implementing one or more embodiments of the present disclosure; and

FIG. 7 is a block diagram of an example data center suitable for use in implementing one or more embodiments of the present disclosure.

### DETAILED DESCRIPTION

One or more embodiments of the present disclosure may relate to implementing a physical mechanism, such as a mechanical selector, that may mechanically switch the operating mode of a control system between a first operating mode and a second operating mode, thereby allowing for the toggling between such operating modes in a mechanical manner. In some embodiments, the first operating mode may include a non-teleassistance mode and the second operating mode may include a teleassistance mode.

In some embodiments, the teleassistance mode may include communicating data with a remote operation system. For example, a control system of an ego-machine may communicate data associated with one or more operations of the control system and/or the ego-machine to a remote operation system. The remote operation system may be located at a remote location away from the ego-machine. Additionally or alternatively, the teleassistance mode may include causing the ego-machine to perform one or more operations (e.g., maneuvering the ego-machine to nearest hospital) based at least on instructions received from the remote operation system. In some embodiments, the instructions provided to the control system from the remote operation system may be based at least on the data received from the ego-machine.

In some embodiments, the control system may be configured to select operating in the first operating mode (e.g., the non-teleassistance mode) or the second operating mode (e.g., the teleassistance mode) based at least on operation of a physical mechanism. In some embodiments, the physical mechanism may include mechanical components that may perform mechanical operations. For example, the physical mechanism may be a mechanical selector. In these and other embodiments, the mechanical selector may be configured to cause selection between the first operating mode and the second operating mode via a mechanical mechanism. For example, the mechanical selector may operate as a physical switch that may be configured to move in a manner that toggles between selecting a first output and a second output. In response to the mechanical selector selecting the first output, the control system may operate in the first operating mode, and in response to the mechanical selector selecting the second output, the control system may operate in the second operating mode.

One or more embodiments of the present disclosure may help improve security associated with operating in a teleassistance mode. For example, some traditional approaches include a control system initiating and communicating with a remote operation system. Such communication between the control system and the remote operation system may provide avenues (e.g., communication channels) in which malicious parties may access data and/or take control of the ego-machine. For example, the malicious parties may engage in teleassistance mode and/or gain control of the ego-machine without physically being present at the ego-machine.

For example, the ego-machine may include a communication module configured to facilitate communication between the control system and the remote operation system. The communication module may communicate with the remote operation system via a network such as cellular networks and dedicated short-range communications (DSRC), among others. Malicious parties not physically present at the ego-machine may provide instructions to the control system of the ego-machine through the communication channel established between the control system and the remote operation system. For example, the malicious parties may gain unauthorized access to the control system, manipulate data being sent between the control system and the remote operation system, overload communication channels, intercept and/or alter communications, among others.

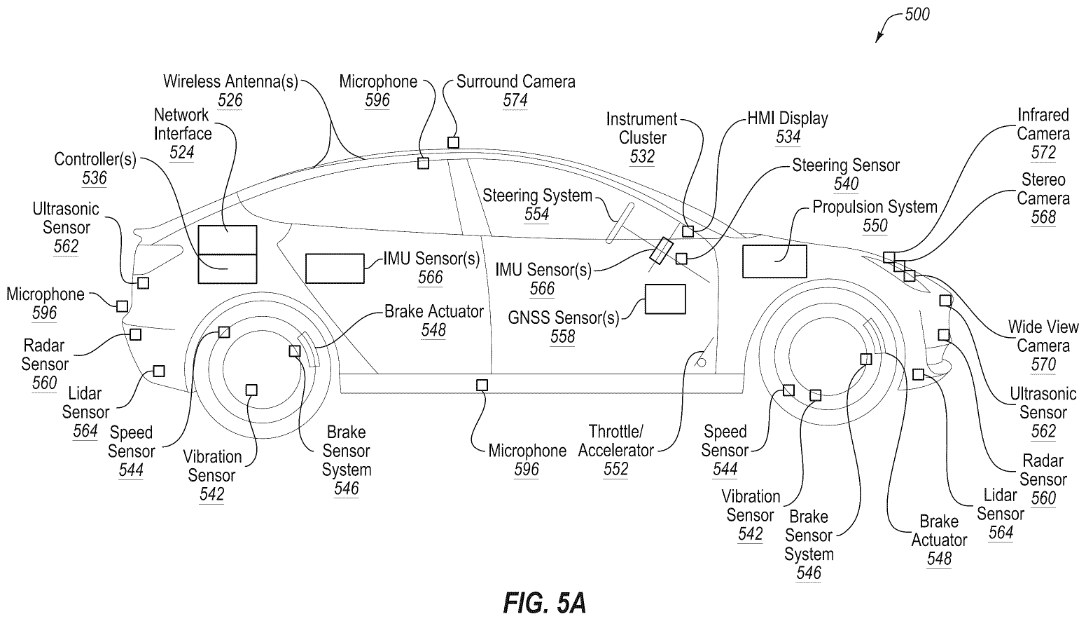

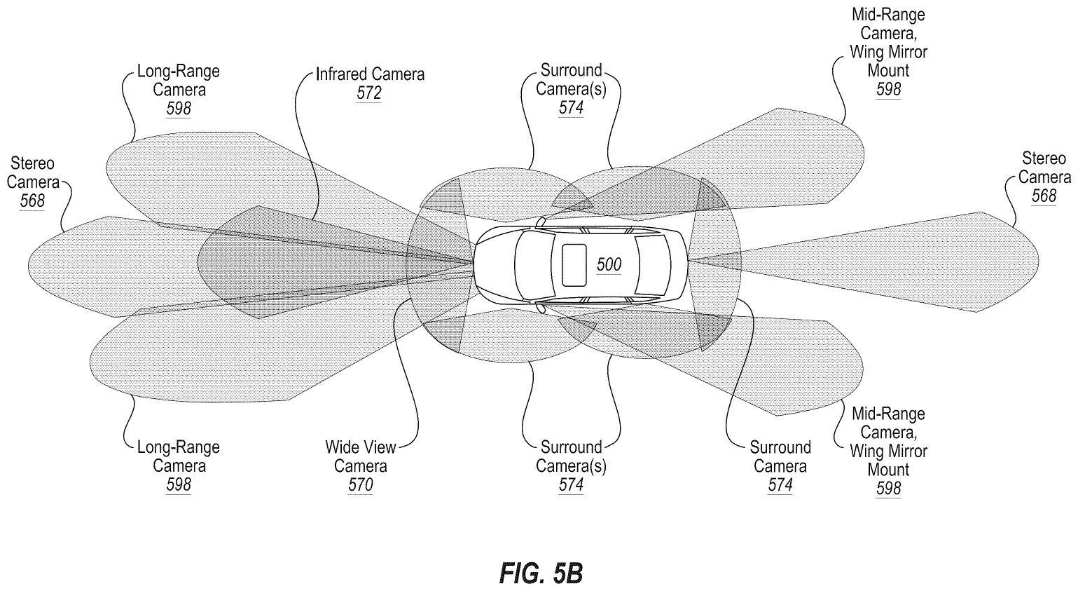

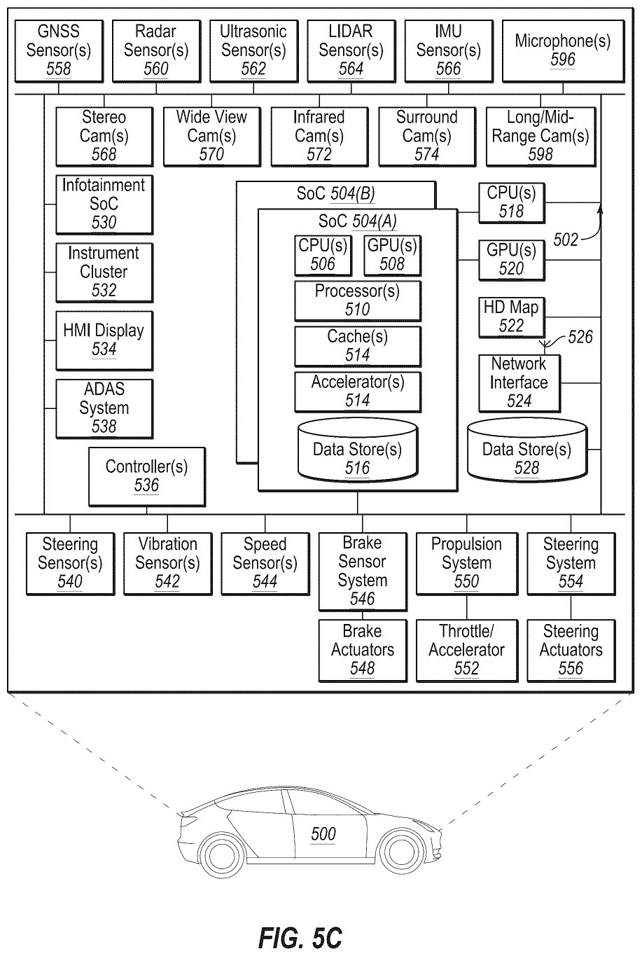

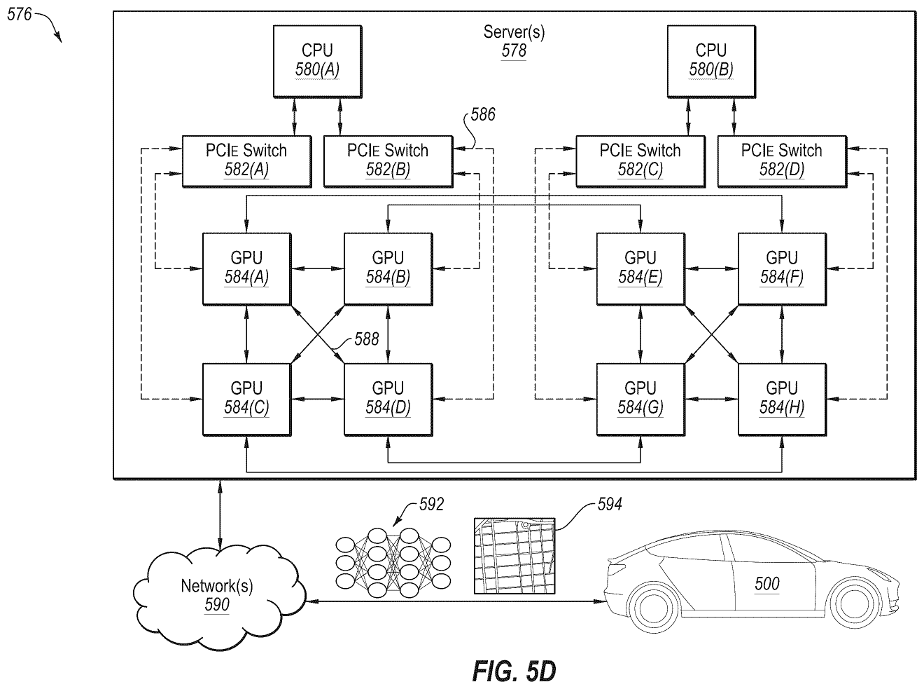

One or more embodiments of the present disclosure may be related to reducing security breaches associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 500 (alternatively referred to herein as “vehicle 500” or “ego-machine 500”) described with respect to FIGS. 5A-5D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI, data center processing, conversational AI (such as by employing one or more language models such as one or more large language models (LLMs), one or more visual language models (VLMs), and/or other model types), light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more language models, such as large language models (LLMs), vision language models (VLMs), multi-modal language models, etc.), systems for performing one or more generative AI operations, systems for hosting real-time streaming applications, systems for presenting one or more of virtual reality content, augmented reality content, or mixed reality content, systems for performing light transport simulation, systems for performing collaborative content creation for 3D assets, systems for performing cybersecurity operations, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

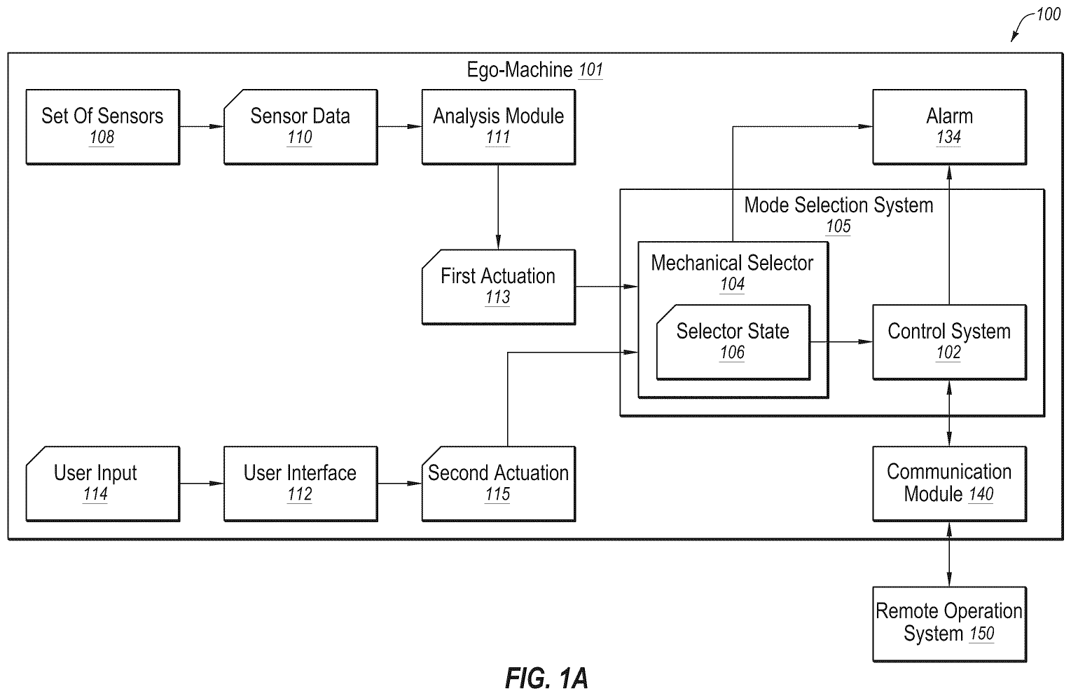

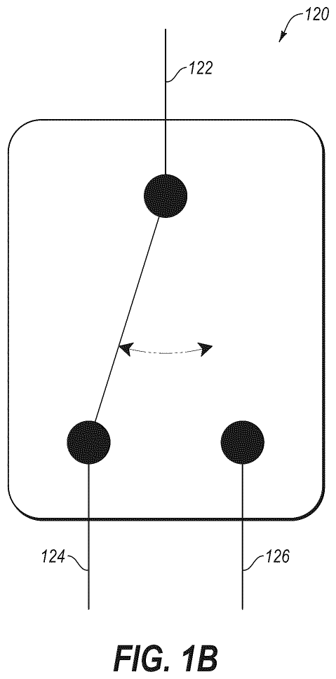

With respect to FIG. 1A, FIG. 1A illustrates an example system 100 configured to select an operating mode of an ego-machine 101, in accordance with one or more embodiments of the present disclosure. In general, the ego-machine 101 may include any suitable machine that may be configured to perform one or more autonomous or semi-autonomous control operations. Further, the system 100 may be generally configured such that one or more of the operating modes may be selected via the use of a physical mechanism, which may help reduce unauthorized parties from selecting certain operating modes. In some embodiments, the system 100 may include the ego-machine 101 and a remote operation system 150. In some embodiments, the ego-machine 101 may include a set of sensors 108, a user interface 112, and a mode selection system 105.

In some embodiments, the set of sensors 108 may be configured to generate sensor data 110. In some embodiments, the set of sensors 108 may be configured detect unforeseen events, such as accidents, associated with the ego-machine. In some embodiments, the sensors 108 may be placed and/or configured such that the sensors 108 may measure force applied to the exterior of the ego-machine. For example, in some embodiments, the set of sensors may be impact sensors associated with the ego-machine 101. In these and other embodiments, the one or more sensors 108 may be configured to detect crumbling or fragmentation of a material or object, such as at least a portion of the ego-machine. For example, the one or more sensors 108 may include vibration sensors, force sensors, strain sensors, acoustic sensors, proximity sensors, among others.

In these and other embodiments, the sensor data 110 may represent an amount or level of impact detected using the set of sensors 108. In some embodiments, the sensor data 110 may numerically represent the amount or level of impact. For example, the sensor data 110 may represent acceleration forces (e.g., intensity and direction of an impact), force exerted on the set of sensors 108 (e.g., magnitude of an impact), rate of rotation (e.g., measure of rotational forces during an impact), among others.

In some embodiments, an analysis module 111 may be configured to analyze the sensor data 110 to identify an occurrence of an impact or unforeseen event that warrants implementation of teleassistance operations. For example, in some embodiments, the analysis module 111 may compare the sensor data 110 with an impact threshold to determine whether the teleassistance operation are warranted. For example, the impact threshold may specify an amount of impact (e.g., acceleration forces, force amount, rate of rotation, among others). In response to the sensor data 110 satisfying (e.g., being equal to or greater than) the impact threshold, the analysis module may generate and/or cause a first actuation 113.

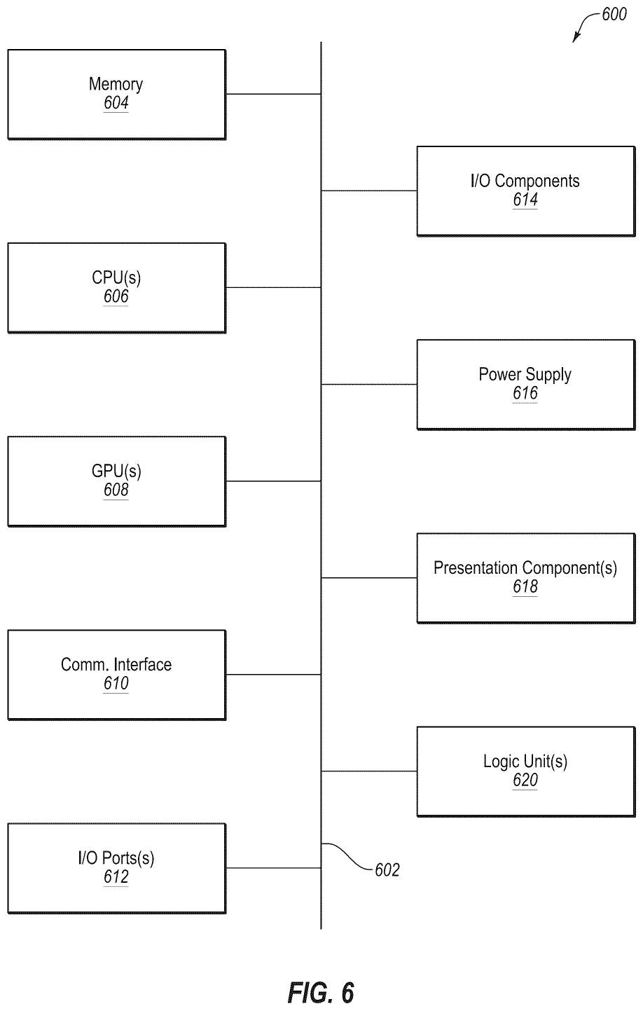

In some embodiments, one or more of the modules and/or processes described herein may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as that described in further detail with respect to FIG. 6.

In some embodiments, the impact threshold may be determined and/or modified based on one or more parameters, such as types of the ego-machines, preferences of the users, level of automation of the ego-machines, among others. For example, the impact threshold may increase (e.g., require greater amount of impact) for larger ego-machines. Additionally or alternatively, the impact threshold may decrease (e.g., require less amount of impact) as the automation level of the ego-machine increases.

In some embodiments, the system 100 may include additional sensors configured to monitor the status and/or health of one or more components of the ego-machine. In some embodiments, individual sensors of the set of sensors 108 may be associated with individual components of the ego-machine. For example, an individual sensor of the set of sensors 108 may be configured to monitor the health and status of an engine of the ego-machine.

In these and other embodiments, the analysis module 111 may be configured to analyze the sensor data 110 to generate the first actuation 113. For example, in some embodiments, the analysis module 111 may compare the sensor data 110 to a threshold. In these and other embodiments, the threshold may represent a minimum health level of the one or more components to facilitate safe operations of the ego-machine. For example, the threshold may specify a temperature of the engine. In instances, in which the engine reaches the temperature, the engine may not be safe to operate.

In some embodiments, the threshold may vary for different components of the ego-machine. For example, the threshold associated with the engine may be different from the threshold associated with transmission of the ego-machine. In these and other embodiments, the threshold for different parts may be determined based at least on a minimum capacity of different parts necessary for safe operation of the ego-machine. In response to the capacity of different parts falling under the threshold, the analysis module 111 may generate the first actuation 113.

In some embodiments, the ego-machine may obtain a user input 114 via the user interface 112. For example, the user interface 112 may include a button that the user may use to signal occurrence of an accident and/or cause implementation of the teleassistance operations. For example, the user may detect an anomaly with the operations of the vehicle (e.g., malfunctioning navigation) and/or face unusual circumstances such as emergencies. In such instances, the user may request open communication with the teleoperator using the one or more user interfaces. In these and other embodiments, in response to obtaining the user input 114, the user interface 112 may cause operation of a second actuation 115.

In some embodiments, the mode selection system 105 may include a mechanical selector 104 and a control system 102. In these and other embodiments, the mode selection system 105 may be configured to select an operating mode of the control system 102. In some embodiments, the first actuation 113 and the second actuation 115 may cause operation of the mechanical selector 104. For example, the mechanical selector 104 may have a selector state 106 representing a position and/or a state of the mechanical selector 104. In some embodiments, the selector state 106 may represent a state of the ego-machine by representing the state of the mechanical selector 104.

In these and other embodiments, the mechanical selector 104 may be a physical mechanism having a first state and a second state. For example, the mechanical selector 104 may be a switch (e.g., rotary switch, slide switch, slide switch, toggle switch), a selector (e.g., push-button selector, cam selector, dial selector), or other mechanisms that may switch or toggle between at least a first position and a second position. The mechanical selector 104 may switch between the first position and the second position via a mechanical movement such as actuation.

For example, FIG. 1B illustrates an example mechanical selector 120, in accordance with one or more embodiments of the present disclosure. In some embodiments, the mechanical selector 120 may correspond to the mechanical selector 104 of FIG. 1A. In some embodiments, the mechanical selector 120 may be a switch configured to toggle between a first state and a second state. For instance, the mechanical selector 120 may be in the first state in instances in which a first terminal 122 is connected to a second terminal 124. The mechanical selector 120 may be in the second state in instances in which the first terminal 122 is connected to a third terminal 126. In some embodiments, the connection between the first terminal 122 and the second terminal 124 may be moved to be between the first terminal 122 and the third terminal 126 in response to an actuation.

In some embodiments, the mechanical selector 120 may switch between the first state and the second state in response to an actuation, such as the first actuation 113 and/or the second actuation 115 of FIG. 1A. For example, an actuation may cause the mechanical selector 120 to switch from the first state to the second state, and from second state to the first state.

Returning to FIG. 1A, in some embodiments, the first actuation 113 and/or the second actuation 115 may cause the selector state 106 of the mechanical selector 104 to switch from the first state to the second state. In some embodiments, a default state of the mechanical selector 104 may be the first state. For example, the selector state 106 may remain in the first state until an actuation (e.g., the first actuation 113 and/or the second actuation 115) causes the mechanical selector 104 to switch. Additionally or alternatively, the first actuation 113 and/or the second actuation 115 may cause the selector state 106 to switch from the second state to the first state.

In some embodiments, the control system 102 may be a set of devices and/or software that is configured to manage, command, direct, facilitate and/or regulate operations of other devices or systems associated with the ego-machine 101. For example, the control system 102 may be configured to obtain data associated with the ego-machine 101, determine operations based at least on the data, and command one or more parts of the ego-machine 101 to operate (e.g., actuation of actuators). Additionally or alternatively, the control system 102 may monitor and adjust the operations based on real-time feedback data. In some embodiments, the control system 102 may be part of or be implemented by one or more computing systems, such as that described in further detail with respect to FIG. 6.

For example, the control system 102 may obtain data from various sensors such as cameras, LiDAR, ultrasonic sensors, gyroscopes, among others. The control system 102 may process the data from the sensors to create a representation of the environment around the ego-machine 101. Additionally or alternatively, the control system 102 may perform planning, pathfinding, and other operations based on one or more decision algorithms that may be applied to the representation of the environment.

In some embodiments, the control system 102 may control communication associated with the ego-machine 101. For example, the control system 102 may initiate and/or control inter-system communication (e.g., communication with other systems and/or vehicles) and intra-system communication (e.g., communication with human operators via user interface).

In some embodiments, operations of the control system 102 may be determined based at least on operating mode of the control system 102. For example, different operating modes may be associated with one or more different operations. In these and other embodiments, the control system 102 may have multiple operating modes. For example, the control system 102 may have at least a first operating mode and a second operating mode. The control system 102 may operate using one of the first operating mode and the second operating mode.

In some embodiments, the first operating mode and the second operating mode may differ with respect to at least teleassistance. For example, in some embodiments, the first operating mode may be a non-teleassistance mode, in which the control system 102 does not perform control operations based on teleassistance commands. The second operating mode may be a teleassistance mode, in which the control system 102 performs one or more control operations based on teleassistance commands.

In these and other embodiments, the teleassistance mode may include the control system 102 communicating with a remote operation system 150. For example, control system 102 may communicate with the remote operation system via a communication module 140. In some embodiments, the communication module 140 may communicate with the remote operation system 150 via a network such as cellular networks and dedicated short-range communications (DSRC), among others. The control system 102 operating in the teleassistance mode may communicate data related to the operations of the ego-machine 101 and/or information on the ego-machine's internal systems to the remote operation system 150. The teleassistance mode may include causing the ego-machine 101 to perform one or more operations based at least on instructions received from the remote operation system 150. For example, the remote operation system 150 may be configured to communicate control commands to the control system 102 and the control system 102 may then cause the ego-machine 101 to perform the one or more control operations (e.g., braking, acceleration, steering, etc.) based on the received control commands.

In some embodiments, the control system 102 may be placed in a particular operating mode based at least on the selector state 106 of the mechanical selector 104. For example, the selector state 106 may dictate the operating mode of the control system 102. In some embodiments, the control system 102 may be configured to operate in the first operating mode in instances in which the selector state 106 is the first state, and the control system 102 may be configured to operate in the second operating mode in instances in which the selector state 106 is the second state.

In some embodiments, the system 100 may include an alarm 134 coupled to the mechanical selector 104 and the control system 102. In these and other embodiments, the alarm 134 may include a component configured to produce a notification such as a loud sound as a waring or alert signal. For example, the alarm 134 may be a hooter configured to produce sound. In some embodiments, the alarm 134 may be configured to produce the notification related to the control system 102 switching from the first operating mode to the second operating mode.

For instance, a delay may occur while the control system 102 is switching and/or rebooting from the first operating mode to the second operating mode based at least on the mode input 134. In such instances, the notification may alert rescuers or other individuals around the ego-machine such that help may be obtained while the control system 102 is switching to the second mode to enable teleassistance.

In some embodiments, the alarm 134 may be configured to generate the notification in a ramp-up mode. For example, the alarm 134 may cause the decibel level of the notification to gradually increase as more time passes. In these and other embodiments, the alarm 134 may continue to increase until the maximum decibel level is reached and/or until the control system 102 notifies the alarm 134 that the control system has completed switching form the first operating mode to the second operating mode. In some embodiments, in response to the control system 102 switching to the second operating mode, the alarm 134 may stop producing the notification.

In some instances, the control system 102 may fail to successfully switch from the first operating mode to the second operating mode for different reasons. For example, the control system 102 may fail to switch due to substantial damage to the ego-machine and/or the control system 102. In such instances, the alarm 134 may ramp up the notification until the highest possible decibel level is reached and continue making the notification at the highest decibel level. In some embodiments, the alarm 134 may continue making the alarm for a certain period. For example, the alarm 134 may produce the notification for 5 minutes, 10 minutes, 15 minutes, 30 minutes, 1 hour, among others. Additionally or alternatively, the alarm 134 may produce the notification until turned off by a user or a rescuer responding to the notification.

In some embodiments, the alarm 134 may operate based on an extent of damage suffered by the ego-machine—which for example may be determined based on the sensor data 110 by the analysis module 111. For example, in some circumstances, an immediate help may be required due to extensive damages to the ego-machine. Contrastingly, in other instances, the ego-machine may experience minor damages such that no immediate help may be needed. In these and other embodiments, an alarm threshold, defining a level of damages, may be set such that the alarm 134 is activated in response to the alarm threshold being satisfied. For example, the alarm threshold may be satisfied in instances in which the extent and/or an estimate of the damages to the ego-machine and/or the users of the ego-machine are greater than or equal to the alarm threshold. In these and other embodiments, the alarm threshold may be determined based on different factors. For example, the alarm threshold may be determined based at least on the sensor data 110 obtained using the sensors 108. For example, the alarm threshold may represent amount of impact the ego-machine experiences. In some embodiments, the alarm threshold may be determined based on the impact threshold. For example, the alarm threshold may be the same as the impact threshold. In these and other embodiments, the alarm 134 may begin producing the notification at the same as the mechanical selector 104 signals the control system 102 to operate in the second operating mode.

Additionally or alternatively, the alarm threshold may be determined based at least on time expected for the control system 102 to switch from the first operating mode to the second operating mode. For example, the alarm threshold may correspond to the time expected for the control system 102 to switch from the first operating mode to the second operating mode. In these and other embodiments, in response to the alarm 134 being prompted to produce notifications based at least on selector signal 106 from the mechanical selector 104, the alarm 134 may wait for the duration of the alarm threshold. In instances in which the control system 102 alerts the alarm 134 of switching operating modes within the alarm threshold, the alarm 134 may not operate. In response to the alarm 134 not obtaining an alert from the control system 102 within the duration of alarm threshold, the alarm 134 may being producing the notifications until the control system 102 alerts the alarm 134.

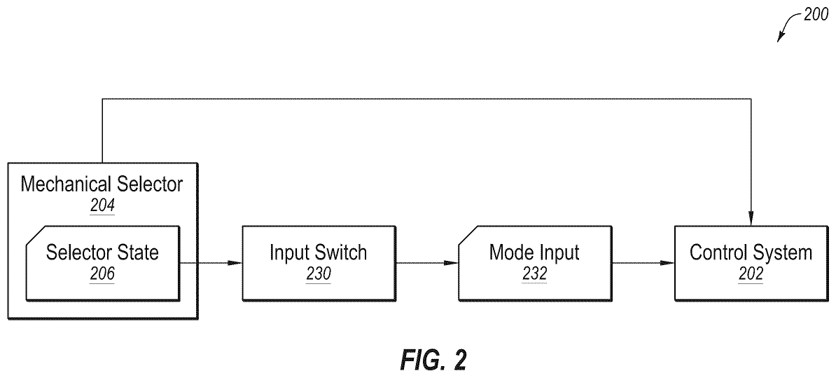

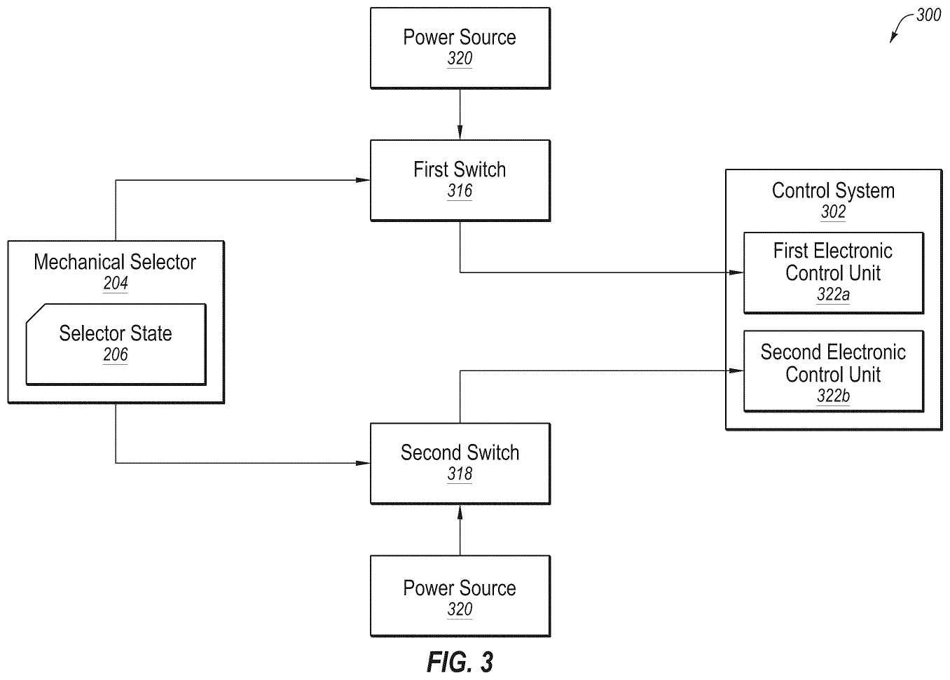

In some embodiments, the system 100 may include a verification system or process such that a false signal to the mechanical selector 104 and/or physical attack on the mechanical selector 104 may be mitigated. For example, false signals may be provided to the mechanical selector 104 from the sensors 108 (e.g., mimicking crumbling), the system health monitor (e.g., second set of sensors), or the user interface 112 (e.g., accidental or false press of the button). In some embodiments, the system 100 may only proceed to initiating the teleassistance operations (e.g., rebooting the control system 202 from the first operating mode to the second operating mode such as shown FIG. 2 or switching from the first ECU 322a to the second ECU 322b in FIG. 3) in response to obtaining a verification signal.

For example, in some embodiments, in response to the selector state 106 switching from the first state to the second state based at least on the first actuation 113, the control system 102 may be configured to directly obtain the sensor data 110 from the sensors 108 or the analysis module 111. The control system 102 may verify that the sensor data 110 warrants the control system 102 switching from the first operating mode to the second operating mode. In instances in which the selector state 106 switches based at least on the user input 114 (e.g., via the second actuation 115), the verification process may request the user to input a verification input. For example, in instances in which the user interface 122 includes a button, the user may be requested to press the button again for verification.

Additionally or alternatively, in some embodiments, in response to, or prior to, the control system 102 switching from the first operating mode to the second operating mode, the remote operation system may perform one or more verification protocols to verify whether switching is proper. For example, the verification protocols may include analysis of information associated with the ego-machine (e.g., to identify unusual situations or accidents), or via communication (e.g., via an operator or an automated system) with the user of the ego machine. In instances in which the remote operation system fails to verify the validity of the switching, the control system 102 may switch back to the first operating mode from the second operating mode or stop the switching process from the first operating mode to the second operating mode.

In some embodiments, the mechanical selector 104 and/or the alarm 134 may be placed within respective protective housings such that the mechanical selector 104 and the alarm 134 may operate in instances of unusual situations and/or accidents. For example, the housings may be manufactured using robust, impact-resistant materials such as plastic or metal. The housings may be designed and manufactured to protect the mechanical selector 104 and/or the alarm 134 from damage during collisions and from environmental factors such as moisture, dust, and temperature fluctuations. Such protections of the mechanical selector 104 and the alarm 134 may provide minimum protection or notification even in instances in which the control system 102 fails to switch to the second operating mode.

Additionally or alternatively, the mechanical selector 104 and/or the alarm 134 may be placed within the ego-machine such that the mechanical selector 104 and the alarm 134 may be impacted relatively less during a collision. For example, the mechanical selector 104 and the alarm 134 may be placed under the dashboard, near the center console, or in the engine compartment of the ego-machine, among others.

Modifications, additions, or omissions may be made to FIG. 1A without departing from the scope of the present disclosure. For example, the system 100 may include more or fewer elements than those illustrated and described in the present disclosure.

FIG. 2 illustrates an example mode selection system 200, in accordance with one or more embodiments of the present disclosure. In some embodiments, the mode selection system 200 may correspond to the mode selection system 105 of FIG. 1A. In some embodiments, the mode selection system 200 may include a mechanical selector 204, an input switch 230, a control system 202.

In some embodiments, the mechanical selector 204 may correspond to the mechanical selector 104 of FIG. 1A. For example, the mechanical selector 204 may have a selector state 206 which may switch between at least a first state and a second state based on an actuation. The actuation may be caused based on one or more of sensor data (e.g., the sensor data 110 of FIG. 1A) or user input (e.g., the user input 114 of FIG. 1A). In some embodiments, the actuation of the mechanical selector 204 may be described in further detail with respect to the mechanical selector 104 of FIG. 1A.

In some embodiments, the input switch 230 may be a switch coupled between the mechanical selector 204 and the control system 202, configured to generate a mode input 232. In some embodiments, the mode input may be a binary pin. For example, the mode input 232 may be “0” or “1” in which “0” indicates the first mode input and “1” indicates the second mode input. In these and other embodiments, the input switch 230 may be any type of switch that may generate the binary output. For example, the input switch 230 may be a single pole double throw (SPDT) switch, a combination of single pole single throw (SPST) switches, a double pole double throw (DPDT) switch, a momentary switch, a slide switch, a rotary switch, among others.

For example, the input switch 230 may have a first terminal, a second terminal, and a third terminal. In these and other embodiments, the first terminal may be connected to ground, the second terminal may be connected to a power source, and the third terminal may be connected to the control system 202. In response to the first terminal and the third terminal being connected, the mode input 232 may represent low voltage (e.g., from the ground). In response to the second terminal and the third terminal being connected, the mode input 232 may represent high voltage (e.g., from the power source). In these and other embodiments, the control system 202 may read the high voltage as “1” and the low voltage as “0”.

In some embodiments, the input switch 230 may be configured to generate the mode input 232 based at least on the selector state 206. For example, in some embodiments, the mechanical selector may cause switching or movement of the input switch 230 based at least on the selector state 206. For example, in some embodiments, the mechanical selector 204 and the input switch 230 may be physically connected such that the change in the selector state 206 causes toggling of the input switch 230.

In some embodiments, the input switch 230 may determine the mode input 232 to be a first mode input or a second mode input. In some embodiments, the mode input 232 may be the first mode input in response to the selector state 206 being the first state, and the mode input 232 may be the second mode input in response to the selector state 206 being the second state.

In some embodiments, the mode input 232 may be a binary pin.

In some embodiments, the control system 202 may select between a first operating mode and a second operating mode based at least on the mode input 232. For example, the control system 202 may select to operate in the first operate mode in response to the mode input 232 being the first mode (e.g., “0”) and select to operate in the second operating mode in response to the mode input 232 being the second mode (e.g., “1”).

In some embodiments, the control system 202 may select between the first operating mode and the second operating mode based on the selector state 206. For example, the control system 202 may be directly connected to the mechanical selector 204, such that the selector state 206 may dictate the operating mode of the control system 202. For example, the selector state 206 may substitute the mode input 232, such that the mode selection system 200 may not include the input switch 230. For example, the first state of the selector state 206 may represent the first mode (e.g., “0”), and the second state of the selector state 206 may represent the second mode (e.g., “1”).

In some embodiments, the control system 202 may switch between the first operating mode and the second operating mode by rebooting. For example, the control system 202 may be operating in the first operating mode (e.g., a default operating mode) with the mode input 232 being in the first mode. The input switch 230 may change the mode input 232 to be the second mode in response to the selector state 206 changing to the second state. For instance, the selector state 206 of the mechanical selector 204 may switch in response to the sensor data and/or the user input. In such instances, the control system 202 may shut down operating in the first operating mode and boot again into the second operating mode. The control system may switch from the second operating mode to the first operating mode in a similar manner in response to the mode input 232 shifting from the second mode to the first mode.

Modifications, additions, or omissions may be made to FIG. 2 without departing from the scope of the present disclosure. For example, the mode selection system 200 may include more or fewer elements than those illustrated and described in the present disclosure.

FIG. 3 illustrates another example mode selection system 300, in accordance with one or more embodiments of the present disclosure. In some embodiments, the mode selection system 300 may correspond to the mode selection system 105 of FIG. 1A. In some embodiments, the system 300 may include a mechanical selector 304, a first switch 316, a second switch 318 and a control system 302.

In some embodiments, the mechanical selector 304 may correspond to the mechanical selector 104 of FIG. 1A. For example, the mechanical selector 304 may have a selector state 306 which may switch between at least a first state and a second state based on an actuation. The actuation may be caused based on one or more of sensor data (e.g., the sensor data 110 of FIG. 1A) or user input (e.g., the user input 114 of FIG. 1A). In some embodiments, the actuation of the mechanical selector 204 may be described in further detail with respect to the mechanical selector 104 of FIG. 1A.

In some embodiments, the first switch 316 may be coupled between the mechanical selector 304 and the control system 302, and the second switch 318 may be coupled between the mechanical selector 304 and the control system 302. In some embodiments, the first switch 316 and the second switch 318 may additionally be coupled to a power source 320, such that the power source 320 provides power to the control system 302 through the first switch or the second switch.

In some embodiments, the mechanical selector 304 may be configured such that the mechanical selector 304 enables, based at least on the selector state 306, one of the first switch 316 or the second switch 318. For example, in some embodiments, the mechanical selector 304 may enable the first switch 316 in instances in which the selector state 306 is in a first state, and the mechanical selector 304 may enable the second switch 318 in instances in which the selector state 306 is in a second state. In these and other embodiments, a switch that is enabled may allow power to flow through the switch, and a switch that is not enabled may not allow power to flow through the switch. In these and other embodiments, only one of the first switch 316 or the second switch 318 may be enabled.

In some embodiments, the control system 302 may include multiple electronic control units (ECUs) associated with multiple operating modes. For example, the control system 302 may include a first ECU 322a associated with a first operating mode and a second ECU 322b associated with a second operating mode. In these and other embodiments, the control system 302 may operate only one of the first ECU 322a or the second ECU 322b such that the control system 302 is operating in the first operating mode or the second operating mode at a given instance depending on which ECU is currently operating.

In these and other embodiments, only one of the first ECU 322a or the second ECU 322b may be operating based at least on the power provided to the first ECU 322a or the second ECU 322b from the power source 320. For example, the first switch 316 may be coupled between the first ECU 322a and the power source, and the second switch 318 may be coupled between the second ECU and the power source 320. In these and other embodiments, the control system 302 may run the first ECU 322a in response to the first switch 316 being enabled, and the control system 302 may run the second ECU 322b in response to the second switch 318 being enabled.

In some embodiments, the mechanical selector 304 may include the first switch 316 and the second switch 318. For example, the mechanical selector 304 may be a three-way switch. For example, the mechanical selector 304 may be connected to the first ECU 322a via a first terminal, the second ECU 322b via a second terminal, and the power source 320 via a third terminal. In these and other embodiments, the mechanical selector may be in a first state or a second state. The first state may be a state in which the first terminal and the third terminal are connected. The second state may be a state in which the second terminal and the third terminal are connected.

Modifications, additions, or omissions may be made to FIG. 3 without departing from the scope of the present disclosure. For example, the mode selection system 300 may include more or fewer elements than those illustrated and described in the present disclosure.

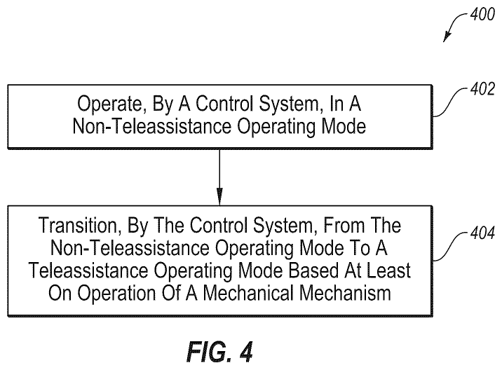

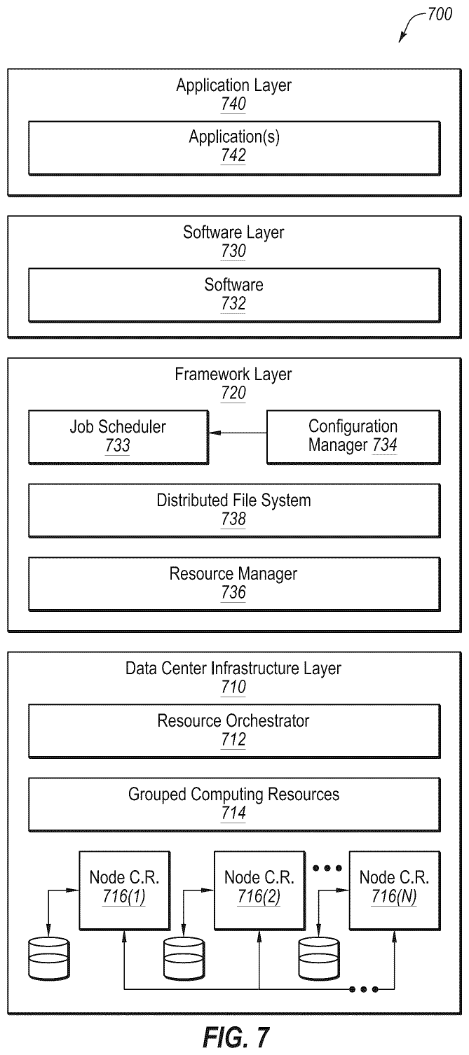

FIG. 4 is a flow diagram illustrating a method 400 for switching an operating mode of a control system, in accordance with one or more embodiments of the present disclosure. One or more operations of the method 400 may be performed by any suitable system, apparatus, or device such as, for example, the system 100 of FIG. 1A, the autonomous vehicle system(s) described with respect to FIGS. 5A-5D, computing device(s) described with respect to FIG. 6, and/or the data system(s) described with respect to FIG. 7 in the present disclosure.

In some embodiments, the control system may be associated with an ego-machine, such as the ego machine 101 of FIG. 1A and/or the autonomous vehicle system(s) described with respect to FIGS. 5A-5D. For example, the control system may be configured to determiner and cause certain operations of the ego-machine. In some embodiments, the ego-machine may operate in a teleassistance mode or a non-teleassistance mode, in which the control system selects between the teleassistance mode and the non-teleassistance mode.

At block 402, the control system may operate in a non-teleassistance operating mode. In some embodiments, the control system may be associated with an ego-machine. For example, the control system may be configured to determine, command, and/or facilitate certain operations associated with the ego-machine. For example, the control system may be configured to obtain data associated with the ego-machine, determine operations based at least on the data, and command one or more parts of the ego-machine to operate (e.g., actuation of actuators). Additionally or alternatively, the control system may monitor and adjust the operations based on real-time feedback data.

At block 404, the control system may transition from the non-teleassistance operating mode to a teleassistance operating mode based at least on operation of a mechanical mechanism. In some embodiments, the mechanical mechanism may correspond to the mechanical selector 104 of FIG. 1A. In some embodiments, the operation of the mechanical mechanism may include switching a state of the mechanical mechanism. For example, the mechanical mechanism may switch between at least a first state and a second state. In some embodiments, the mechanical mechanism may switch between the first state and the second state based on one or more of impact sensor data or user input. In some embodiments, the switching of states of the mechanical mechanism may be described in further detail in the present disclosure, such as with respect to the mechanical selector 104 of FIG. 1A.

In some embodiments, transitioning from the non-operating mode to the teleassistance operating mode may include rebooting the control system to switch from the non-teleassistance operating mode to the teleassistance operating mode. In some embodiments, the rebooting process may be discussed in further detail with respect to the control system 202 of FIG. 2.

In some embodiments, the control system may include multiple electronic control units (ECUs). For example, the control system may include a first ECU (e.g., the first ECU 322a of FIG. 3) and a second ECU (e.g., the second ECU 322b of FIG. 3). In these and other embodiments, transitioning from the non-operating mode to the teleassistance operating mode may include causing a selection between first operations being controlled by the first ECU of the control system and second operations being controlled by the second ECU of the control system. In some embodiments, operations of the first ECU and the second ECU may be described in further detail in the present disclosure, such as with respect to the first ECU 322a and the second ECU 322b of FIG. 3.

In some embodiments, the control system may transition from the non-teleassistance operating mode to the teleassistance operating mode based at least on impact sensor data generated by one or more impact sensors (e.g., the set of sensors 108 of FIG. 1A) or user input data generated by user interface (e.g., the user interface 112 of FIG. 1A). The impact sensors may be configured to detect crumbling or fragmentation of a material or object, such as at least a portion of the ego-machine. For example, the impact sensors may include vibration sensors, force sensors, strain sensors, acoustic sensors, proximity sensors, among others. The impact sensors may generate impact sensor data may representing amount of crumbling or fragmentation.

In these and other embodiments, the control system may transition from the non-teleassistance operating mode to the teleassistance operation mode in response to the impact sensor data indicating that an impact threshold has been satisfied. For example, an analysis module (e.g., the analysis module 111 of FIG. 1A) may determine, based on the analysis of the sensor data, that switch to the teleassistance operation mode is warranted. The analysis module may cause the state of the mechanical mechanism to switch. For example, the analysis module may cause actuation that may switch the state of the mechanical mechanism. The switch in the state of the mechanical mechanism may cause the control system to transition from the non-teleassistance operation mode to the teleassistance operation mode.

In some embodiments, the control system may transition from the non-teleassistance operating mode to the teleassistance operation mode in response to obtaining the user input via the user interface. For example, the user interface may include a button that a user may use to signal occurrence of an accident and/or cause implementation of the teleassistance operations. In response to obtaining the user input, the user interface may cause actuation of the mechanical mechanism such that the state of the mechanical mechanism switches, in which the control system may transition between the non-teleassistance operation mode and the teleassistance operation mode accordingly. In some embodiments, the operations of the user interface may be described in further detail with respect to the user interface 112 of FIG. 1A.

In some embodiments, the transitioning may be based at least on sensor data obtained using one or more sensors configured to monitor condition of one or more components of the ego-machine. For example, the one or more sensors may monitor and identify instances in which the one or more components are not functioning properly or safely. For example, one of the one or more sensors may be monitoring the health of an engine of the ego-machine. In response to detecting temperature of the engine that is not considered safe, the control system may be configured to transition from the non-teleassistance operating mode to the teleassistance operating mode. For example, the analysis module may analyze the condition of the one or more components based on the senso data. In response to determining that the teleassistance operation mode is warranted, the analysis module may switch the state of the mechanical mechanism such that the control system transitions from the non-teleassistance operation mode to the teleassistance operation mode.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

For example, in some embodiments, he method 400 may further include causing, by the control system, an alarm to generate a notification related to switching from the non-teleassistance operating mode to the teleassistance operating mode. The alarm may generate the notification such that rescuers and/or other people around the ego-machine may be alerted. In some embodiments, operations of the alarm may be described in further detail in the present disclosure, such as with respect to the alarm 134 of FIG. 1A.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surrounding at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100 m, with an accuracy of 2 cm-3 cm, and with support for a 100 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A system comprising:
a control system for controlling one or more operations of a machine, the control system having a first operating mode and a second operating mode, wherein the first operating mode includes a non-teleassistance mode and the second operating mode include a teleassistance mode; and
a mechanical selector to cause selection between the first operating mode and the second operating mode via a mechanical mechanism.

The system of Example 1, wherein the teleassistance mode includes one or more of:
communicating data with a remote operation system; or
causing the machine to perform one or more control operations based at least on data received from the remote operation system.

The system of Example 1, wherein the system further comprises one or more impact sensors to generate impact sensor data; and
the mechanical selector is configured to cause selection from the first operating mode to the second operating mode based at least on the impact sensor data.

The system of Example 1, wherein the control system includes a first electronic control unit associated with the first operating mode;
the control system includes a second electronic control unit associated with the second operating mode; and
the mechanical selector is configured to cause selection between the first operating mode and the second operating mode at least by causing a selection between first operations being controlled by the first electronic control unit and second operations being controlled by the second electronic control unit.

The system of Example 1, wherein:
the system includes a power source;
a first switch coupled between the first electronic control unit and the power source;
a second switch coupled between the second electronic control unit and the power source; and
the mechanical selector is configured to cause the selection between first operations being controlled by the first electronic control unit and second operations being controlled by the second electronic control unit by controlling power being provided from the power source to one of the first electronic control unit or the second electronic control unit via the first switch or the second switch, respectively.

The system of Example 1, further comprising a user interface coupled to the mechanical selector, wherein the mechanical selector is configured to cause selection from the first operating mode to the second operating mode based at least on user input received at the user interface.

The system of Example 1, wherein the system further comprises an input switch configured to provide a mode input to the control system, the control system selecting to operate in the first operating mode or the second operating mode based at least on the mode input; and
the mechanical selector is configured to cause selection between the first operating mode and the second operating mode at least by controlling the input switch, wherein the control system is configured to reboot to switch between the first operating mode and the second operating mode based at least on the mode input.

The system of Example 1, further comprising an alarm configured to generate a notification related to switching from the first operating mode to the second operating mode.

The system of Example 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

Example 2. A method comprising:
operating, by a control system, in a non-teleassistance operating mode; and
   transitioning, by the control system, from the non-teleassistance operating mode to a teleassistance operating mode based at least on operation of a mechanical mechanism.

The method of Example 2, wherein the transitioning from the non-teleassistance operating mode to the teleassistance operating mode includes causing a selection between first operations being controlled by a first electronic control unit of the control system and second operations being controlled by a second electronic control unit of the control system.

The method of Example 2, wherein the transitioning from the non-teleassistance operating mode to the teleassistance operating mode includes rebooting to switch from the non-teleassistance operating mode to the teleassistance operating mode.

The method of Example 2, wherein the transitioning from the non-teleassistance operating mode to the teleassistance operating mode is based at least on impact sensor data generated by one or more impact sensors or user input data generated by user interface, wherein the transitioning from the non-teleassistance operating mode to the teleassistance operating mode is in response to the impact sensor data indicating that an impact threshold has been satisfied.

The method of Example 2, wherein the transitioning from the non-teleassistance operating mode to the teleassistance operating mode is based at least on sensor data obtained using one or more sensors configured to monitor condition of one or more components of an ego-machine.

The method of Example 2, causing, by the control system, an alarm to generate a notification related to switching from the non-teleassistance operating mode to the teleassistance operating mode.

Example 3. One or more processors comprising:
processing circuitry to cause performance of operations comprising:
operating, by a control system, in a first operating mode, wherein the first operating mode includes a non-teleassistance mode and the second operating mode include a teleassistance mode; and
transitioning, by the control system, from the first operating mode to a second operating mode based at least on operation of a mechanical mechanism.

The one or more processors of Example 3, wherein the transitioning from the first operating mode to the second operating mode includes causing a selection between first operations being controlled by a first electronic control unit of the control system and second operations being controlled by a second electronic control unit of the control system.

The one or more processors of Example 3, wherein the transitioning from the first operating mode to the second operating mode includes rebooting to switch from the first operating mode to the second operating mode.

What is claimed is:

1. A system comprising:
a control system for controlling one or more operations of a machine, the control system having a first operating mode and a second operating mode, wherein the first operating mode includes a non-teleassistance mode and the second operating mode include a teleassistance mode; and
a mechanical selector to cause selection between the first operating mode and the second operating mode via a mechanical mechanism.

2. The system of claim 1, wherein the teleassistance mode includes one or more of:
communicating data with a remote operation system; or
causing the machine to perform one or more control operations based at least on data received from the remote operation system.

3. The system of claim 1, wherein:
the system further comprises one or more impact sensors to generate impact sensor data; and
the mechanical selector is configured to cause selection from the first operating mode to the second operating mode based at least on the impact sensor data.

4. The system of claim 1, wherein:
the control system includes a first electronic control unit associated with the first operating mode;
the control system includes a second electronic control unit associated with the second operating mode; and
the mechanical selector is configured to cause selection between the first operating mode and the second operating mode at least by causing a selection between first operations being controlled by the first electronic control unit and second operations being controlled by the second electronic control unit.

5. The system of claim 4, wherein:
the system includes a power source;
a first switch coupled between the first electronic control unit and the power source;
a second switch coupled between the second electronic control unit and the power source; and
the mechanical selector is configured to cause the selection between first operations being controlled by the first electronic control unit and second operations being controlled by the second electronic control unit by controlling power being provided from the power source to one of the first electronic control unit or the second electronic control unit via the first switch or the second switch, respectively.

6. The system of claim 1, further comprising a user interface coupled to the mechanical selector, wherein the mechanical selector is configured to cause selection from the first operating mode to the second operating mode based at least on user input received at the user interface.

7. The system of claim 1, wherein:
the system further comprises an input switch configured to provide a mode input to the control system, the control system selecting to operate in the first operating mode or the second operating mode based at least on the mode input; and
the mechanical selector is configured to cause selection between the first operating mode and the second operating mode at least by controlling the input switch.

8. The system of claim 7, wherein the control system is configured to reboot to switch between the first operating mode and the second operating mode based at least on the mode input.

9. The system of claim 1, further comprising an alarm configured to generate a notification related to switching from the first operating mode to the second operating mode.

10. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

11. A method comprising:
operating, by a control system, in a non-teleassistance operating mode; and
transitioning, by the control system, from the non-teleassistance operating mode to a teleassistance operating mode based at least on operation of a mechanical mechanism.

12. The method of claim 11, wherein the transitioning from the non-teleassistance operating mode to the teleassistance operating mode includes causing a selection between first operations being controlled by a first electronic control unit of the control system and second operations being controlled by a second electronic control unit of the control system.

13. The method of claim 11, wherein the transitioning from the non-teleassistance operating mode to the teleassistance operating mode includes rebooting to switch from the non-teleassistance operating mode to the teleassistance operating mode.

14. The method of claim 11, wherein the transitioning from the non-teleassistance operating mode to the teleassistance operating mode is based at least on impact sensor data generated by one or more impact sensors or user input data generated by user interface.

15. The method of claim 14, wherein the transitioning from the non-teleassistance operating mode to the teleassistance operating mode is in response to the impact sensor data indicating that an impact threshold has been satisfied.

16. The method of claim 11, wherein the transitioning from the non-teleassistance operating mode to the teleassistance operating mode is based at least on sensor data obtained using one or more sensors configured to monitor condition of one or more components of an ego-machine.

17. The method of claim 11, further comprising:
causing, by the control system, an alarm to generate a notification related to switching from the non-teleassistance operating mode to the teleassistance operating mode.

18. One or more processors comprising:
processing circuitry to cause performance of operations comprising:
operating, by a control system, in a first operating mode, wherein the first operating mode includes a non-teleassistance mode; and
transitioning, by the control system, from the first operating mode to a second operating mode based at least on operation of a mechanical mechanism, wherein the second operating mode include a teleassistance mode.

19. The one or more processors of claim 18, wherein the transitioning from the first operating mode to the second operating mode includes causing a selection between first operations being controlled by a first electronic control unit of the control system and second operations being controlled by a second electronic control unit of the control system.

20. The one or more processors of claim 18, wherein the transitioning from the first operating mode to the second operating mode includes rebooting to switch from the first operating mode to the second operating mode.
